(19) United States
(12) Patent Application Publication
(10) Pub. No.: US 2022/0071318 A1
(43) Pub. Date: Mar. 10, 2022

(54) NECK WARMER

(71) Applicant: DANNY LEE, CARLSTADT, NJ (US)

(72) Inventor: DANNY LEE, CARLSTADT, NJ (US)

(21) Appl. No.: 17/016,728

(22) Filed: Sep. 10, 2020

(51) Int. Cl. A41D 13/11; A41D 23/00; A62B 18/08; A62B 23/02

(52) U.S. Cl. CPC A41D 13/1107; A41D 13/1161; A41D 23/00; A41D 2500/40; A62B 23/025; A41D 2300/20; A41D 2300/50; A62B 18/084

(57) ABSTRACT

The present invention is a neck warmer that includes a mask member, a filtration material, a closable aperture, a nose holder, a first stitching, a second stitching, and a third stitching. The mask member has a top, a bottom, a front and an interior. The mask member fits flexible material encircling and covering the nose, mouth and neck area of a wearer. The filtration material has one or more filter layers. The one or more filter layers have material sufficient to reduce a presence of certain substances in air that passes through the one or more filter layers. The closable aperture is attached to the interior of the front of the mask member. The closable aperture is sized to receive the filtration material. The nose holder is attached to the interior of the front of the mask member. The nose holder has a first and second nose portions. The first and second nose portions firmly cover the nose of the wearer. The first stitching and the second stitching are secured respectively to two opposite sides of the mask member. The third stitching forms a seam is positioned between the first stitching and the second stitching.

### TECHNICAL FIELD & BACKGROUND

The present invention generally related to a neck warmer, and in particular, to an improved neck warmer. Typical neck warmers are worn to filter out only particles making air breathable for the wearer. The wearers who are outside can encounter a variety of airborne irritants. For example, the wearers can be exposed to not only particles but also bacteria and viruses from people with symptoms nearby. Further, typical neck warmers often slip and slide around a wearer's face.

A variety of neck warmers have been available in the past, however, these neck warmers frequently do not filter well allowing air to pass between the neck warmer and wearer's face. Thus, such typical neck warmers that only offer limited wearer protection could increase negative health consequences.

Therefore, it would be desirable to provide an improved neck warmer that not only prevents the neck warmer from moving around a wearer's face, but also protects the wearers from bacteria and viruses from people with symptoms nearby.

### SUMMARY OF THE INVENTION

The present invention is directed to a neck warmer that overcomes the above-mentioned disadvantages of the prior art.

In one aspect, the present invention provides a neck warmer having a mask member, a filtration material, a closable aperture, a nose holder, a first stitching, a second stitching, and a third stitching. The mask member has a top, a bottom, a front and an interior. The interior is contoured to fit over the nose and mouth of the wearer. The mask member fits flexible material encircling and covering the nose, mouth and neck area of a wearer. The flexible material around the neck area is capable of stretching over the nose and snugly constricting around the neck. The filtration material has a top edge, a bottom edge and an inner surface. The inner surface is configured to cover the nose and mouth of the wearer. The filtration material has one or more filter layers. The one or more filter layers have material sufficient to reduce a presence of certain substances in air that passes through the one or more filter layers. The closable aperture is attached to the interior of the front of the mask member. The closable aperture is sized to receive the filtration material. The nose holder is attached to the interior of the front of the mask member. The nose holder has a first and second nose portions. The first and second nose portions firmly cover the nose of the wearer. The nose holder hugs the front of the nose of the wearer. The nose holder is formed from a semi-rigid or flexible material. The nose holder is biased inward and provides tension to the mask member. The first stitching has a circular shape. The first stitching is adjacent to the top of the mask member. The first stitching forms a seam that in it is entirety is spaced from the top of the mask member. The second stitching has a circular shape. The second stitching is adjacent to the bottom of the mask member. The second stitching forms a seam that in it is entirety is spaced from the bottom of the mask member. The third stitching has a circular shape. The third stitching forms a seam being positioned between the first stitching and the second stitching. The third stitching is secured to the mask member.

In another aspect, the present invention provides a neck warmer having a mask member, a filtration material, a closable aperture, a nose holder, a first stitching, a second stitching, and a third stitching. The mask member has a top, a bottom, a front and an interior. The interior is contoured to fit over the nose and mouth of the wearer. The mask member fits flexible material encircling and covering the nose, mouth and neck area of a wearer. The flexible material around the neck area is capable of stretching over the nose and snugly constricting around the neck. The filtration material has a top edge, a bottom edge and an inner surface. The inner surface is configured to cover the nose and mouth of the wearer. The filtration material has one or more filter layers. The one or more filter layers have material sufficient to reduce a presence of certain substances in air that passes through the one or more filter layers. The closable aperture is attached to the interior of the front of the mask member. The closable aperture is sized to receive the filtration material. The closable aperture is sewn to the mask member. The closable aperture is securely closed after the closable aperture is filled with the filtration material such that the filtration material remains within the closable aperture. The nose holder is attached to the interior of the front of the mask member. The nose holder has a first and second nose portions. The first and second nose portions firmly cover the nose of the wearer. The nose holder hugs the front of the nose of the wearer. The nose holder is formed from a semi-rigid or flexible material. The nose holder is biased inward and provides tension to the mask member. The first stitching has a circular shape. The first stitching is adjacent to the top of the mask member. The first stitching forms a seam that in it is entirety is spaced from the top of the mask member. The second stitching has a circular shape. The second stitching is adjacent to the bottom of the mask member. The second stitching forms a seam that in it is entirety is spaced from the bottom of the mask member. The first stitching and the second stitching are secured respectively to two opposite sides of the mask member. The third stitching has a circular shape. The third stitching forms a seam being positioned between the first stitching and the second stitching. The third stitching is secured to the mask member.

In a further aspect, the present invention provides a neck warmer having a mask member, a filtration material, a closable aperture, a nose holder, a first stitching, a second stitching, and a third stitching. The mask member has a top, a bottom, a front and an interior. The interior is contoured to fit over the nose and mouth of the wearer. The mask member fits flexible material encircling and covering the nose, mouth and neck area of a wearer. The flexible material around the neck area is capable of stretching over the nose and snugly constricting around the neck. The filtration material has a top edge, a bottom edge and an inner surface. The inner surface is configured to cover the nose and mouth of the wearer. The filtration material has one or more filter layers. The one or more filter layers have material sufficient to reduce a presence of certain substances in air that passes through the one or more filter layers. The closable aperture is attached to the interior of the front of the mask member. The closable aperture is sized to receive the filtration material. The closable aperture is sewn to the mask member. The closable aperture is securely closed after the closable aperture is filled with the filtration material such that the filtration material remains within the closable aperture. The nose holder is attached to the interior of the front of the mask member. The nose holder has a first and second nose portions. The first and second nose portions firmly cover the nose of the wearer. The nose holder hugs the front of the nose of the wearer. The nose holder is formed from a semi-rigid or flexible material. The nose holder is biased inward and provides tension to the mask member. The first stitching has a circular shape. The first stitching is adjacent to the top of the mask member. The first stitching forms a seam that in it is entirety is spaced from the top of the mask member. The second stitching has a circular shape. The second stitching is adjacent to the bottom of the mask member. The second stitching forms a seam that in it is entirety is spaced from the bottom of the mask member. The first stitching and the second stitching are secured respectively to two opposite sides of the mask member. The first stitching and the second stitching are in spaced parallel relationship. The third stitching has a circular shape. The third stitching forms a seam being positioned between the first stitching and the second stitching. The third stitching is secured to the mask member.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a perspective view of a neck warmer, in accordance with one embodiment of the present invention.

FIG. 2 illustrates a front view of a neck warmer, in accordance with one embodiment of the present invention.

FIG. 3 illustrates a back view of a neck warmer, in accordance with one embodiment of the present invention.

FIG. 4 illustrates a side view of a neck warmer, in accordance with one embodiment of the present invention. FIG. 5 illustrates an interior of a mask member of a neck warmer, in accordance with one embodiment of the present invention.

FIG. 6 illustrates a top view of a neck warmer, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments. Various operations will be described as multiple discrete operations, in turn, in a manner that is most helpful in understanding the present invention. However, the order of description should not be construed as to imply that these operations are necessarily order dependent. In particular, these operations need not be performed in the order of presentation. The phrase “in one embodiment” is used repeatedly. The phrase generally does not refer to the same embodiment, however, it may. The terms “comprising”, “having” and “including” are synonymous, unless the context dictates otherwise.

This present invention provides an improved neck warmer that not only prevents the neck warmer from moving around a wearer's face, but also protects the wearers from bacteria and viruses from people with symptoms nearby.

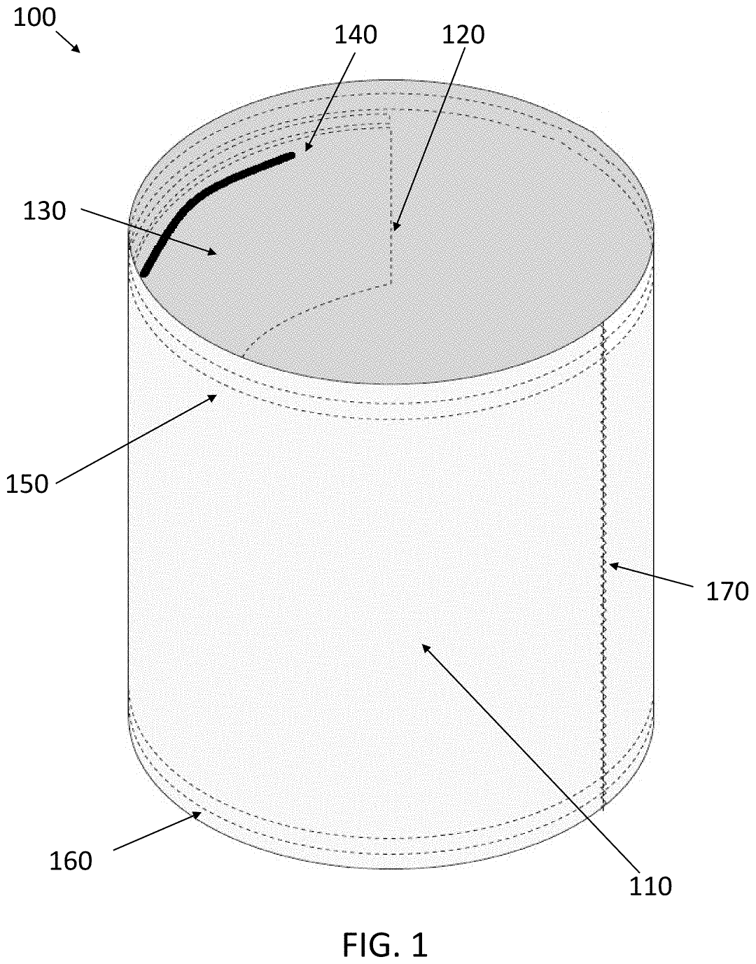

FIG. 1 illustrates a perspective view of a neck warmer 100, in accordance with one embodiment of the present invention.

Referring to FIG. 1, a neck warmer 100 includes a mask member 110, a filtration material 120, a closable aperture 130, a nose holder 140, a first stitching 150, a second stitching 160, and a third stitching 170.

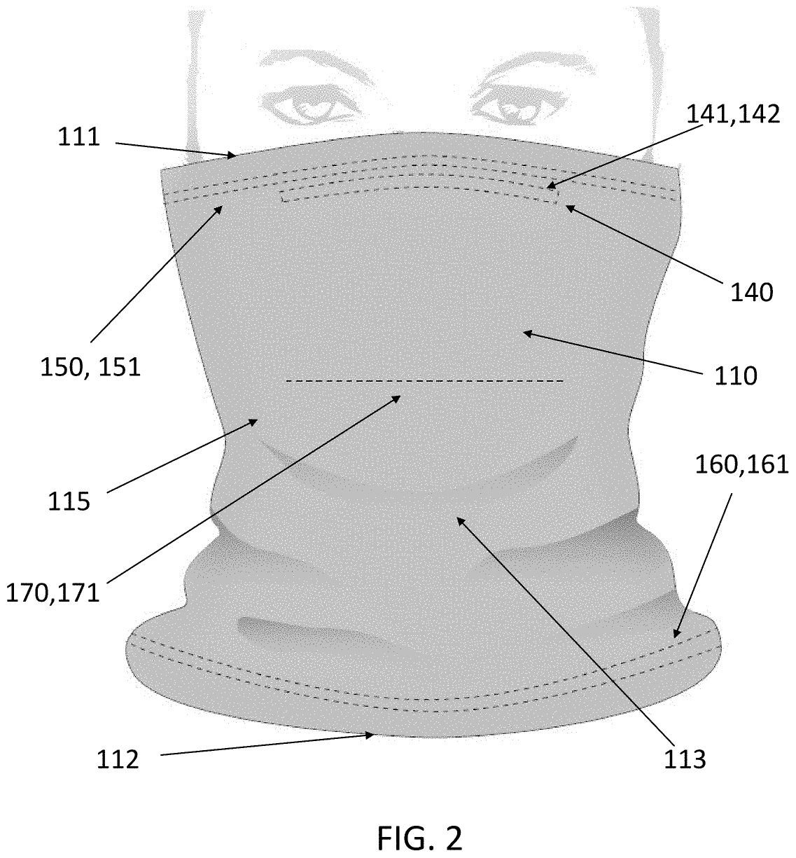

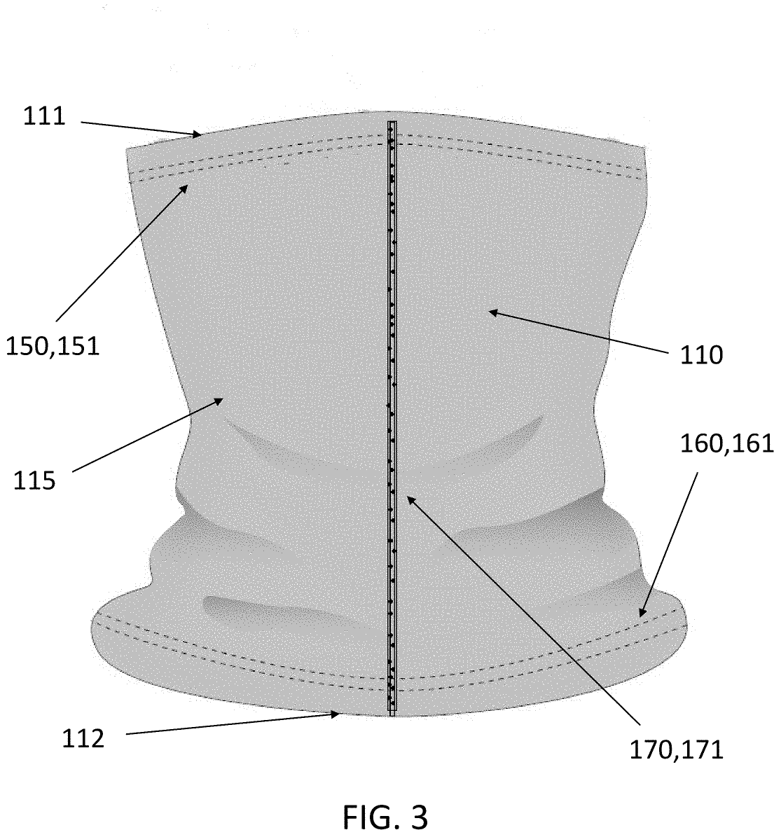

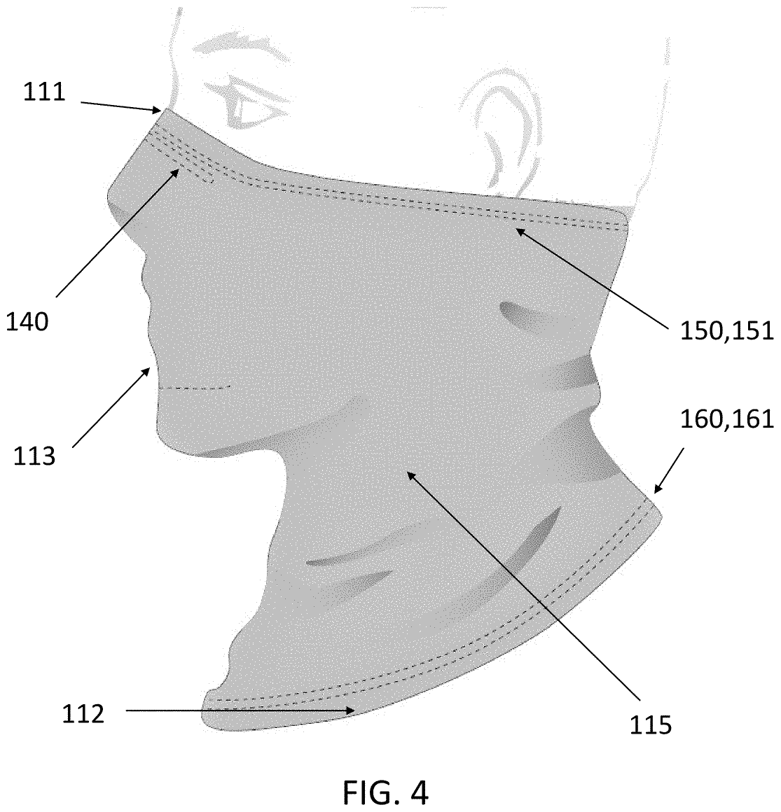

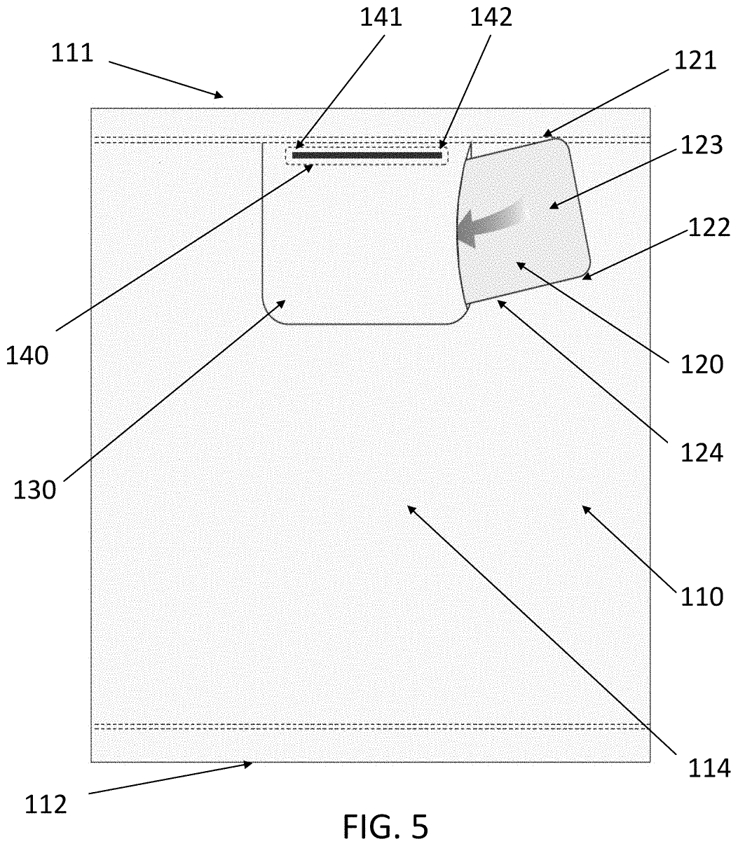

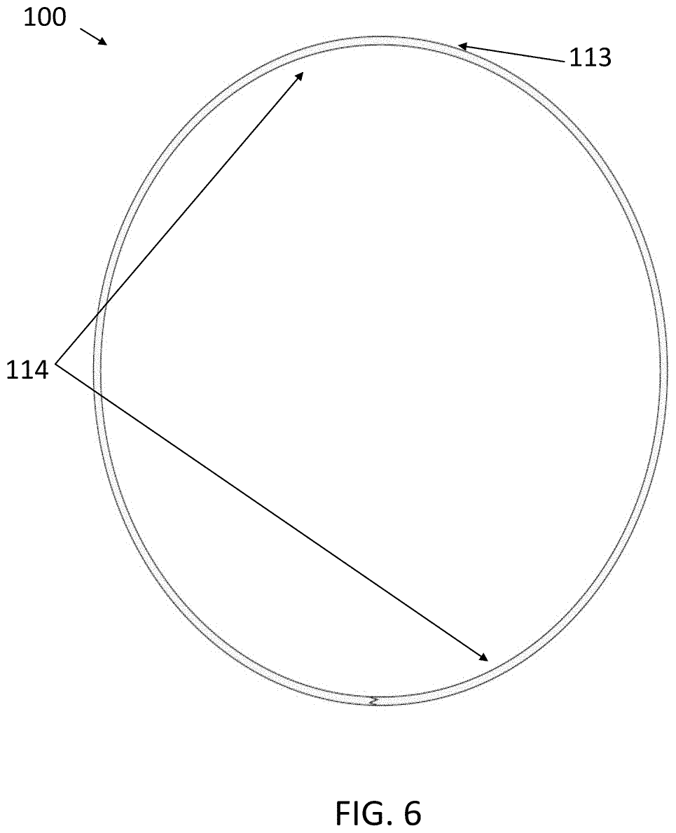

FIG. 2 illustrates a front view of a neck warmer 100, in accordance with one embodiment of the present invention. FIG. 3 illustrates a back view of a neck warmer 100, in accordance with one embodiment of the present invention. FIG. 4 illustrates a side view of a neck warmer 100, in accordance with one embodiment of the present invention. FIG. 6 illustrates a top view of a neck warmer 100, in accordance with one embodiment of the present invention.

In an exemplary embodiment, and as illustrated in FIGS. 2, 3, 4 and 6, the mask member 110 has a top 111, a bottom 112, a front 113 and an interior 114. The interior 114 is contoured to fit over the nose and mouth of the wearer. The mask member 110 fits flexible material 115 encircling and covering the nose, mouth and neck area of a wearer. The flexible material 115 around the neck area is capable of stretching over the nose and snugly constricting around the neck. The mask member 110 is sufficiently long to cover the nose, mouth and neck of the wearer.

The mask member 110 may comprise material suitable for graphic decoration. The front 113 of the mask member 110 may provide a convenient surface for a wearer to graphically decorate such as drawings or text. The mask member 110 may further comprise a leather material. The mask member 110, which may be comprised of an elastic material or other material sufficiently stretchable to provide enough tension to hold a neck warmer 100 to a wearer's face when place on the wearer's face, typically over the nose. Preferably, the flexible material 115 comprises one or more materials selected from the group consisting of: cotton, microfiber, synthetic fiber, polypropylene, polyethylene, wool, silk, satin, bamboo, rayon, polyester, and poly-urethane. The mask member 110 may further comprise at least one of a waterproof material and a water resistant material.

FIG. 5 illustrates an interior 114 of a mask member 110 of a neck warmer 100, in accordance with one embodiment of the present invention.

In an exemplary embodiment, and as illustrated in FIG. 5, the filtration material 120 has a top edge 121, a bottom edge 122 and an inner surface 123. The inner surface 123 is configured to cover the nose and mouth of the wearer. The filtration material 120 has one or more filter layers 124. The one or more filter layers 124 have material sufficient to reduce a presence of certain substances in air that passes through the one or more filter layers.

The one or more filter layers 124 may be made of any suitable filter material. Preferably, the one or more filter layers 124 are comprised of a non-woven material, a paperboard material, or any other sufficiently breathable and strong material that can reduce the presence of certain bacteria and viruses.

Referring to FIG. 5, the closable aperture 130 is attached to the interior 114 of the front 113 of the mask member 110. The closable aperture 130 is sized to receive the filtration material 120. The closable aperture 130 is sewn to the mask member 110. The closable aperture 130 is securely closed after the closable aperture 130 is filled with the filtration material 120 such that the filtration material 120 remains within the closable aperture 130.

The closable aperture 130 can be attached to the interior 114 in a variety of ways, including stitching and adhesives. However, the closable aperture 130 is preferably affixed to the interior via a stitching that securely holds the closable aperture 130 in position. Thus, the closable aperture 130 remains securely attached to the interior 114 when the filtration material 120 is bent or bowed around the nose of the wearer.

Preferably, the closable aperture 130 comprises one or more materials selected from the group consisting of: cotton, microfiber, synthetic fiber, polypropylene, polyethylene, wool, silk, satin, bamboo, rayon, polyester, and poly-urethane.

Referring to FIGS. 2 and 5, the nose holder 140 is attached to the interior 114 of the front 113 of the mask member 110. The nose holder 140 has a first and second nose portions 141, 142. The first and second nose portions 141, 142 firmly cover the nose of the wearer. The nose holder 140 hugs the front of the nose of the wearer. The nose holder 140 is formed from a semi-rigid or flexible material. The nose holder 140 is biased inward and provides tension to the mask member 110. The nose holder 140 can be attached to the interior 114 of the front 113 of the mask member 110 in a variety of ways, including stitching and adhesives. However, the nose holder 140 is preferably affixed to the interior 114 via a stitching that securely holds the nose holder 140 in position. Another benefit of the nose holder 140 is that it allows a neck warmer 100 to assume and maintain a substantially cupped shape when the neck warmer 100 is in a three dimensional configuration. Preferably, the nose holder 140 may be comprised of a metal, plastic, or other suitable flexible, semi-rigid material that can be bent by a person after placing a neck warmer 100 on his or her face to improve the fit of neck warmer 100. A nose holder 140 may further comprise a metal wire or a strip encapsulated in a plastic sheet, and may be secured by stitching or heat welding to the interior 114 of the mask member 110.

Referring to FIGS. 1-5, the first stitching 150 has a circular shape. The first stitching 150 is adjacent to the top 111 of the mask member 110. The first stitching 150 forms a seam 151 that in it is entirety is spaced from the top 111 of the mask member 110.

The second stitching 160 has a circular shape. The second stitching 160 is adjacent to the bottom 112 of the mask member 110. The second stitching 160 forms a seam 161 that in it is entirety is spaced from the bottom 112 of the mask member 110.

The first stitching 150 and the second stitching 160 are secured respectively to two opposite sides of the mask member 110. The first stitching 150 and the second stitching 160 are in spaced parallel relationship.

The third stitching 170 has a circular shape. The third stitching 170 forms a seam 171 being positioned between the first stitching 150 and the second stitching 160. The third stitching 170 is secured to the mask member 110.

Thus, the present invention disclosed herein provides an improved neck warmer that not only prevents the neck warmer from moving around a wearer's face, but also protects the wearers from bacteria and viruses from people with symptoms nearby implementing extra protection with such filtration material and nose holder. While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A neck warmer, comprising:
a mask member having a top, a bottom, a front and an interior, the interior being contoured to fit over the nose and mouth of the wearer, the mask member fitting flexible material encircling and covering the nose, mouth and neck area of a wearer, the flexible material around the neck area being capable of stretching over the nose and snugly constricting around the neck;
a filtration material having a top edge, a bottom edge and an inner surface, the inner surface being configured to cover the nose and mouth of the wearer, the filtration material having one or more filter layers, the one or more filter layers having material sufficient to reduce a presence of certain substances in air that passes through the one or more filter layers;
a closable aperture attached to the interior of the front of the mask member, the closable aperture being sized to receive the filtration material;
a nose holder attached to the interior of the front of the mask member, the nose holder having a first and second nose portions, the first and second nose portions firmly covering the nose of the wearer, the nose holder hugging the front of the nose of the wearer, the nose holder being formed from a semi-rigid or flexible material, the nose holder being biased inward and providing tension to the mask member;
a first stitching having a circular shape, the first stitching being adjacent to the top of the mask member, the first stitching forming a seam that in it is entirety is spaced from the top of the mask member;
a second stitching having a circular shape, the second stitching being adjacent to the bottom of the mask member, the second stitching forming a seam that in it is entirety is spaced from the bottom of the mask member; and
a third stitching having a circular shape, the third stitching forming a seam being positioned between the first stitching and the second stitching, the third stitching being secured to the mask member.

2. The neck warmer according to claim 1, wherein the flexible material comprises one or more materials selected from the group consisting of: cotton, microfiber, synthetic fiber, polypropylene, polyethylene, wool, silk, satin, bamboo, rayon, polyester, and poly-urethane.

3. The neck warmer according to claim 1, wherein the closable aperture comprises one or more materials selected from the group consisting of: cotton, microfiber, synthetic fiber, polypropylene, polyethylene, wool, silk, satin, bamboo, rayon, polyester, and poly-urethane.

4. The neck warmer according to claim 1, wherein the mask member comprises material suitable for graphic decoration.

5. The neck warmer according to claim 1, wherein the mask member comprises at least one of a waterproof material and a water resistant material.

6. The neck warmer according to claim 1, wherein the mask member comprises a leather material.

7. The neck warmer according to claim 1, wherein the one or more filter layers comprise a paperboard material.

8. A neck warmer, comprising:
a mask member having a top, a bottom, a front and an interior, the interior being contoured to fit over the nose and mouth of the wearer; the mask member fitting flexible material encircling and covering the nose, mouth and neck area of a wearer, the flexible material around the neck area being capable of stretching over the nose and snugly constricting around the neck;
a filtration material having a top edge, a bottom edge and an inner surface, the inner surface being configured to cover the nose and mouth of the wearer, the filtration material having one or more filter layers, the one or more filter layers having material sufficient to reduce a presence of certain substances in air that passes through the one or more filter layers;
a closable aperture attached to the interior of the front of the mask member, the closable aperture being sized to receive the filtration material, the closable aperture being sewn to the mask member;
wherein the closable aperture is securely closed after the closable aperture is filled with the filtration material such that the filtration material remains within the closable aperture;
a nose holder attached to the interior of the front of the mask member, the nose holder having a first and second nose portions, the first and second nose portions firmly covering the nose of the wearer, the nose holder hugging the front of the nose of the wearer, the nose holder being formed from a semi-rigid or flexible material, the nose holder being biased inward and providing tension to the mask member;
a first stitching having a circular shape, the first stitching being adjacent to the top of the mask member, the first stitching forming a seam that in it is entirety is spaced from the top of the mask member;
a second stitching having a circular shape, the second stitching being adjacent to the bottom of the mask member, the second stitching forming a seam that in it is entirety is spaced from the bottom of the mask member;
wherein the first stitching and the second stitching are secured respectively to two opposite sides of the mask member; and
a third stitching having a circular shape, the third stitching forming a seam being positioned between the first stitching and the second stitching, the third stitching being secured to the mask member.

9. The neck warmer according to claim 8, wherein the flexible material comprises one or more materials selected from the group consisting of: cotton, microfiber, synthetic fiber, polypropylene, polyethylene, wool, silk, satin, bamboo, rayon, polyester, and poly-urethane.

10. The neck warmer according to claim 8, wherein the closable aperture comprises one or more materials selected from the group consisting of: cotton, microfiber, synthetic fiber, polypropylene, polyethylene, wool, silk, satin, bamboo, rayon, polyester, and poly-urethane.

11. The neck warmer according to claim 8, wherein the mask member comprises material suitable for graphic decoration.

12. The neck warmer according to claim 8, wherein the mask member comprises at least one of a waterproof material and a water resistant material.

13. The neck warmer according to claim 8, wherein the mask member comprises a leather material.

14. The neck warmer according to claim 8, wherein the one or more filter layers comprise a paperboard material.

15. A neck warmer, comprising:
a mask member having a top, a bottom, a front and an interior, the interior being contoured to fit over the nose and mouth of the wearer; the mask member fitting flexible material encircling and covering the nose, mouth and neck area of a wearer, the flexible material around the neck area being capable of stretching over the nose and snugly constricting around the neck;
a filtration material having a top edge, a bottom edge and an inner surface, the inner surface being configured to cover the nose and mouth of the wearer, the filtration material having one or more filter layers, the one or more filter layers having material sufficient to reduce a presence of certain substances in air that passes through the one or more filter layers;
a closable aperture attached to the interior of the front of the mask member, the closable aperture being sized to receive the filtration material, the closable aperture being sewn to the mask member;
wherein the closable aperture is securely closed after the closable aperture is filled with the filtration material such that the filtration material remains within the closable aperture;
a nose holder attached to the interior of the front of the mask member, the nose holder having a first and second nose portions, the first and second nose portions firmly covering the nose of the wearer, the nose holder hugging the front of the nose of the wearer, the nose holder being formed from a semi-rigid or flexible material, the nose holder being biased inward and providing tension to the mask member;
a first stitching having a circular shape, the first stitching being adjacent to the top of the mask member, the first stitching forming a seam that in it is entirety is spaced from the top of the mask member;
a second stitching having a circular shape, the second stitching being adjacent to the bottom of the mask member, the second stitching forming a seam that in it is entirety is spaced from the bottom of the mask member;
wherein the first stitching and the second stitching are secured respectively to two opposite sides of the mask member, the first stitching and the second stitching being in spaced parallel relationship; and
a third stitching having a circular shape, the third stitching forming a seam being positioned between the first stitching and the second stitching, the third stitching being secured to the mask member.

16. The neck warmer according to claim 15, wherein the flexible material comprises one or more materials selected from the group consisting of: cotton, microfiber, synthetic fiber, polypropylene, polyethylene, wool, silk, satin, bamboo, rayon, polyester, and poly-urethane.

17. The neck warmer according to claim 15, wherein the closable aperture comprises one or more materials selected from the group consisting of: cotton, microfiber, synthetic fiber, polypropylene, polyethylene, wool, silk, satin, bamboo, rayon, polyester, and poly-urethane.

18. The neck warmer according to claim 15, wherein the mask member comprises material suitable for graphic decoration.

19. The neck warmer according to claim 15, wherein the mask member comprises at least one of a waterproof material and a water resistant material.

20. The neck warmer according to claim 15, wherein the one or more filter layers comprise a paperboard material.
